(19) United States
(12) Patent Application Publication
(10) Pub. No.: US 2025/0214616 A1
(43) Pub. Date: Jul. 3, 2025

(54) VEHICLE CONTENT ITEM PROJECTION

(71) Applicant: GM Cruise Holdings LLC, San Francisco, CA (US)

(72) Inventors: Yafei Han, Sunnyvale, CA (US); Fen Chen, Morgan Hill, CA (US); Vignesh Vishwanathan, San Francisco, CA (US); Xuefeng Wang, Cupertino, CA (US)

(21) Appl. No.: 18/403,518

(22) Filed: Jan. 3, 2024

(51) Int. Cl. B60W 60/00

(52) U.S. Cl. CPC B60W 60/0011; B60W 2400/00; B60W 2420/403; B60W 2554/402; B60W 2554/404; B60W 2900/00

(57) ABSTRACT

Systems, methods, and non-transitory computer readable mediums are provided for projecting one or more content items onto a surface outside of an AV. For example, a system may receive routing data including routing information and road agent information of each of one or more road agents within a predetermined distance threshold of an autonomous vehicle (AV). Additionally, the system may generate projection data including a content item associated with the routing information and the road agent information. Moreover, the system may provide projection data to a projection controller device communicating with one or more projection devices. The projection controller device may cause at least one of the one or more projection devices to project the content item onto a surface outside of the AV.

### BACKGROUND

### 1. Technical Field

The present disclosure generally relates to projecting images onto surfaces and, more specifically, projecting one or more images that indicate the intent of an autonomous vehicle (AV).

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an exemplary computing environment that can be used to facilitate autonomous vehicle (AV) image projection operations, according to some examples of the present disclosure;

FIGS. 2-4 illustrate diagrams of portions of the exemplary computing environment, according to some examples of the present disclosure;

FIG. 5 illustrates a flowchart of an exemplary process for projecting one or more images corresponding to an intent of an autonomous vehicle (AV), according to some examples of the present disclosure;

FIGS. 6-9 illustrate an examples of content item projections in different environments;

FIG. 10 illustrates an example of a deep learning neural network, according to some aspects of the disclosed technology; and

FIG. 11 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

With the increasing number of driverless cars or autonomous vehicles (AVs) operating on public roads, a significant challenge arises due to the absence of vehicle operators in the AVs. Specifically, an AV on the road may not be able to communicate an action or intent the AV is planning to perform to other road agents near the AV. Examples of road agents that may be near or around the AV include, drivers, such as human drivers, operating other vehicles, other autonomous vehicles, pedestrians, and cyclists. As such, it may be difficult for the other road agents to understand and predict the behavior of the AV.

As described herein, a computing system, such as a projection system, generate information characterizing one or more actions or operations the AV may perform based on sensor data generated by one or more sensors of the AV. Additionally, the computing system may communicate with one or more projection devices and cause the one or more projection devices to project content visible to one or more road agents and on a surface outside of the AV, such as a surface of the road the AV may be on. The content may correspond to the one or more actions or operations the AV may perform. As such, based on the projected visible content, road agents outside of the AV may better understand and predict the behavior of the AV, which may help enhance overall road safety with regards to the AV.

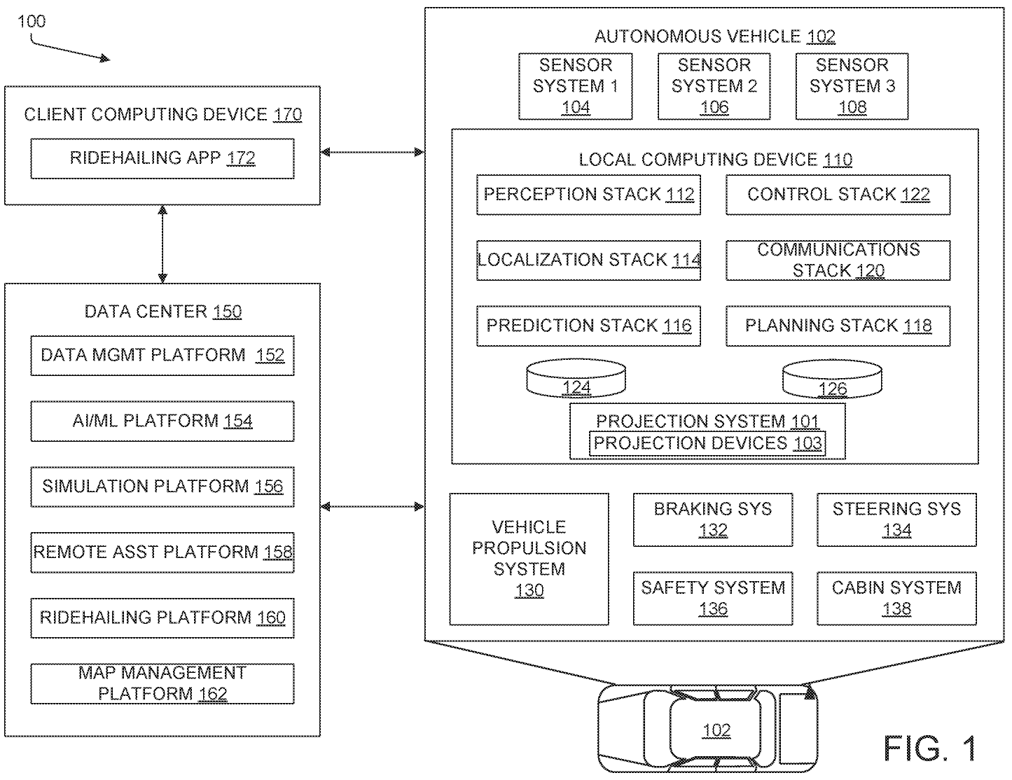

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

As illustrated in FIG. 1, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

As described herein, AV 102 may include projection system 101. Projection system 101 may include one or more projection devices 103 configured to project one or more content items onto surfaces outside of AV 102. Although FIG. 1 illustrates projection system 101 including the one or more projection devices 103, in some instances, the one or more projection devices 103 may be separate from projection system 101. Examples of the one or more projection devices 103 include a laser projector, a digital light processing projection device, a liquid crystal display projection device, a light emitting diode projection device, and a liquid crystal on silicon projection device. Additionally, the one or more projection devices 103 may be coupled or attached to various locations of AV 102. In some instances, the one or more projection devices 103 may be positioned on the front, rear, roof, undercarriage and/or sides of AV 102. In instances where the one or more projection devices 103 are positioned in the front of AV 102, the one or more projection devices 103 may be integrated into the headlamps of AV 102. In instances, where the one or more projection devices 103 are positioned on the sides of AV 102, the one or more projection devices 103 may be integrated into the indicators of the side view mirrors of AV 102. In various instances, AV 102 may include sensor pods, in such instances, the one or more projection devices may be integrated into one or more of the sensor pods. Moreover, projection system 101 may determine, identify, and obtain the one or more content items to be projected by the one or more projection devices 103.

In some examples, projection system 101 may determine or identify the one or more content items to be projected by the one or more projection devices 103 based on routing or planning data generated by planning stack 118. As described herein, routing or planning data may include information characterizing a set of one or more mechanical operations or maneuvers AV 102 may safely and efficiently perform in its environment. For instance, the set of mechanical operations or maneuvers may be associated with traveling from a first location to a second location. In such examples, the planning data may be based on localization data, prediction data and perception data. Additionally, the localization data and perception data may be based on sensor data generated by one or more of multiple sensor systems of AV 102.

As illustrated in FIG. 1, AV 102 may include multiple sensor systems 104, 106, and 108. The multiple sensor systems 104, 106, and 108 can include one or more types of sensors and can be arranged about the AV 102. In such examples, one or more of the multiple sensor systems 104, 106, 108 may include one or more types of sensors and can be arranged about AV 102. Examples of sensors that the one or more sensors, such as sensor systems 104, 106 and 108, may include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, sensor system 104 can be a camera system, sensor system 106 can be a LIDAR system, and the sensor system 108 can be a RADAR system. Other examples may include any other number and type of sensors.

As described herein, the sensor data generated by the one or more of the multiple sensor systems 104, 106 and 108, may be associated with and characterize one or more road agents that AV 102 may encounter or may have encountered. By way of example, sensor system 106 may be a LIDAR system and sensor data generated by sensor system 106 may include a set of data points in a three-dimensional coordinate system. Additionally, the set of data points may be a diagrammatic representation of an environment that AV 102 may be in. Moreover, subsets of the set of data points may each correspond to one or more objects, such as road agents, that AV 102 has encountered or is encountering. Further, each data point of each subset of the data points may represent a single spatial measurement on the surface of an object included in the corresponding area, such as a pedestrian that AV 102 has encountered or is encountering.

Referring back to FIG. 1, the one or more of multiple sensor systems, such as sensor systems 104, 106 and 108, may provide sensor data to localization stack 114. Localization stack 114 may generate localization data based on the sensor data (e.g., sensor data generated from GPS, IMUs, cameras, LIDAR, RADAR, ultrasonic sensors, etc.). As described herein, the localization data may indicate the location and/or pose of AV 102. Additionally, the location of AV 102 may be the current location of AV 102, while the pose of AV 102 may be the position and orientation of AV 102. In some examples, the localization data may be further based on HD map data stored in HD geospatial database 126. For example, in some cases, localization stack 114 may compare sensor data captured in real-time by one or more sensor systems, such as sensor systems 104, 106 and 108 to HD map data stored in HD geospatial database 126 to determine its precise (e.g., accurate to the order of a few centimeters or less) position and orientation.

In some examples, the HD map data stored in HD geospatial database 126 may include a set of data points in a three-dimensional coordinate system. Additionally, the HD map data may be a diagrammatic representation of geographic areas that AV 102 may travel in. Moreover, each data point of the set of data points may represent a single spatial measurement on the surface of an object in the geographic areas, such as a building. Further, the HD map data may characterize multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

Referring back to FIG. 1, the one or more sensor systems, such as sensor systems 104, 106 and 108, may provide sensor data to perception stack 112. Perception stack 112 may generate perception data based on the sensor data (e.g., sensor data generated from cameras, LIDAR sensors, infrared sensors, microphones, ultrasonic sensors, RADAR, pressure sensors, force sensors, impact sensors, etc.). In some examples, the perception data may be based on localization data generated by localization stack 114. As described herein, the perception data may identify and classify objects, such as road agents, around AV 102. Additionally, the perception data may include information characterizing, for each identified object, a corresponding current location, speed, direction, and the like. Moreover, the perception information may include information characterizing, for each identified object, the free space around the AV 102.

Further, the perception data may identify environmental uncertainties, such as where to look for moving objects, flag areas that may be obscured or blocked from view, and so forth. In some examples, the perception data may characterize a bounding area around a perceived or identified object, such as a road agent. Additionally, the bounding area may be associated with a semantic label that identifies the type of object that is within the bounding area, the kinematic of the object (information about its movement), a tracked path of the object, and a description of the pose of the object (its orientation or heading, etc.).

Referring back to FIG. 1, prediction stack 116 may utilize perception data and localization data to generate prediction data. As described herein, the prediction information may identify and characterize, for each object identified in the perception information, a predicted trajectory and/or future path for the object. In some examples, the prediction information may identify and characterize, for each object identified in the perception information, multiple future paths for the object and/or trajectories. In such examples, the prediction information, may include, for each predicted future path and/or trajectory of each object identified in the perception data, a likelihood the object may follow the predicted future path and/or trajectory. Additionally, for each predicted path, the prediction data may include a range of points along the path corresponding to a predicted location of the object along the path at future time intervals along with an expected error value for each of the points that indicates a probabilistic deviation from that point.

As illustrated in FIG. 1, planning stack 118 may generate the planning data based on prediction data and perception data. For example, planning stack 118 may determine multiple sets of one or more mechanical operations or maneuvers that the AV 102 can perform based on the prediction information and the perception information (e.g., location, speed, and direction of the AV 102, geospatial data, data regarding objects, such as road agents, sharing the road with the AV 102 or certain events occurring during the trip, such as emergency vehicle blaring a siren, intersections, occluded areas, street closures for construction or street repairs, double-parked cars, traffic rules and other safety standards or practices for the road, user input, and other relevant data). Examples of the one or more mechanical operations includes go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; and decelerate until completely stopped and reverse. Additionally, planning stack 118 may select the best one of the multiple sets of one or more mechanical operations or maneuvers that AV 102 can perform to meet changing road conditions and events. Moreover, planning stack 118 may generate planning data that identifies the selected set of one or more mechanical operations or maneuvers.

In some examples the multiple sets of one or more mechanical operations may be implemented in the event an unexpected event occurs. For example, while preparing to change lanes to turn right at an intersection, another vehicle may aggressively cut into the destination lane, making the lane change unsafe. Planning stack 118 could have already determined an alternative plan for such an event. Upon its occurrence, planning stack 118 may select the alternative plan for AV 102 to perform, such as to go around the block instead of blocking a current lane while waiting for an opening to change lanes.

Referring back to FIG. 1, projection system 101 may utilize the planning data generated by planning stack 118 to determine and obtain one or more content items to be projected by one or more projection devices 103. In some examples, projection system 101 may access a content item database that stores the one or more content items that may be each projected by the one or more projection devices 103. As described herein, the content item stored in the content item database may be associated with or correspond to one or more mechanical operations or maneuvers that AV 102 may perform. Additionally, the content item may include data identifying the set of the one or more mechanical operations or maneuvers. Examples of the content item that may be stored in content item database include, a right arrow corresponding to a right turn, a left arrow corresponding to a left turn, a “s-shaped” arrow with a shaded box corresponding to a lane change, a reverse arrow corresponding to reversing, text indicating AV 102 is about to stop or is stopping, and in some instances, an animation, such as a countdown indicating how long until AV 102 is to stop or to move again. Moreover, projection system 101 may obtain the content item corresponding with the set of the one or more mechanical operations or maneuvers included in the planning data.

Additionally, or alternatively, projection system 101 may further utilize perception data to determine and obtain a content item to be projected by the one or more projection devices 103. In some examples, the perception data may indicate, for each object around AV 102, a type of road agent. Additionally, the content items stored in the content item database may include data indicating an associated type of road agent. For example, a particular type of arrow may be associated with pedestrians, while another type of arrow may be associated with other vehicles or bicyclists. Additionally, projection system 101 may access the content item database to determine which content item is associated with a set of one or more mechanical operations or maneuvers characterized in the planning data and the type of road agent identified in the perception data. Further, projection system 101 may obtain the content item that includes data identifying set of one or more mechanical operations or maneuvers characterized in the planning data and the type of road agent identified in the perception data.

In some instances, projection system 101 may obtain content items for one or more road agents that are within a predetermined threshold distance from AV 102. In such instances, projection system 101 may utilize the perception data to identify one or more objects that are within a predetermined threshold distance from AV 102. Additionally, projection system 101 may determine which of the one or more objects are road agents, based on one or more portions of perception data associated with each of the one or more objects that are within a predetermined threshold distance from AV 102. Moreover, executed projection engine 300 may determine, for each object identified as a road agent, the type of road agent, based on one or more portions of perception data associated with each of object identified as a road agent. Further, projection system 101 may access the content item database to determine, for each object identified as a road agent, a content item that is associated with a set of one or more mechanical operations or maneuvers characterized in the planning data and the identified road agent type.

In some examples, projection system 101 may generate projection parameter data. The projection parameter data may identify one or more projection parameters associated with the projection of one or more content items by one or more projection devices 103. In some instances, the one or more projection parameters may identify a position or location the content item is to be projected onto. In such instances, projection system 101 may determine the one or more projection parameters associated with the position or location the content item is to be projected onto based on one or more portions of perception data and/or prediction data of one or more road agents around AV 102. For instance, the position or location may be on a surface, such as a road surface, near AV 102 and in front of a pedestrian near AV 102. In such an instance, projection system 101 may determine a pose or orientation and location of the pedestrian based on one or more portions of perception data and/or prediction data of the pedestrian. Additionally, projection system 101 may determine, for a content item, a position or location that is in front of the pedestrian based on the determined pose/orientation and location of the pedestrian. Moreover, projection system 101 may generate projection parameter data that identifies and characterizes the location or position. Further and the one or more projection devices 103 may project the content item at the location or position identified and characterized by the projection parameter data.

In other instances, the one or more projection parameters may indicate a brightness or level of light intensity (e.g., between 100 and cd/m\hat{ }2) for a content item. In such instances, one or more projection devices 103 may project the content item at a level of light intensity or brightness in accordance with such projection parameters. In one instance, the one or more projection parameters associated with a brightness or level of light intensity for the content item may be based on a light level of an environment that AV 102 is in. Additionally, projection system 101 may generate the one or more projection parameters associated with a brightness or level of light intensity for the content item based on perception data associated with the projected content item. In such an instance, the perception data may indicate the level of light intensity of an environment that the content item is projected in. In another instance, the one or more projection parameters associated with a brightness or level of light intensity for the content item may be additionally or alternatively based on a color of a surface that the one or more projection devices 103 may project the content item onto. In such an instance, the perception data may indicate a color of a surface the one or more projection devices 103 may project the content item onto, such as a road surface. Additionally, projection system 101 may generate the one or more projection parameters associated with a brightness or level of light intensity for the content item based additionally or alternatively on the in part on perception data indicating the color of the surface the one or more projection devices 103 may project the content item onto.

In various instances, the one or more projection parameters may indicate a color of a content item to be projected by the one or more projection devices 103. Additionally, projection system 101 may determine the one or more projection parameters associated with a color based on perception data associated with the environment that AV 102 is in. In such instances, projection system 101 may utilize one or more projection criteria to determine whether the content item will be legible on a surface that the one or more content items may be projected on. By way of example, the one or more projection criteria may be associated with a color contrast level associated with a surface the one or more content items may be projected onto. The color contrast level may ensure the brightness of the content item may be different enough compared to the surface so that the content item is visible. Additionally, the perception data of an environment that AV 102 is in may indicate a color of a surface the one or more projection devices 103 may project the content item onto, such as a road surface. Moreover, projection system 101 may utilize the perception data and the projection criteria associated with a color contrast level to determine a color for the content item. For instance, the perception data may indicate the surface is grey and of a first brightness level and, as such, projection system 101 may determine the color for the content item may be white at a second brightness level. Further, projection system 101 may generate the one or more projection parameters associated with the color of the content item based on the determined color, and the one or more projection devices 103 may project the content item in accordance with the one or more projection parameters associated with the determined color.

In some instances, the one or more projection parameters may indicate a size of the content item to be projected by the one or more projection devices 103. In such instances, one or more projection devices 103 may project the content item at a particular size in accordance with such projection parameters. Additionally, and in some instances, the one or more projection parameters associated with a size for the content item may be based on characteristics of one or more road agents the content item is projected for, such as the type of the road agent and the distance between the road agent and AV 102. In such instances, projection system 101 may generate the one or more projection parameters associated with a size for the content item based on perception data and/or prediction data of the road agent. Additionally, the perception data and/or the prediction data of the road agent may indicate the type of the corresponding road agent and the distance between the road agent and AV 102. For instance, for a vehicle type road agent compared to a pedestrian type of road agent, projection system 101 may determine the size of the content item for the vehicle type road agent may be bigger than the size of the content item for the pedestrian type road agent. In another instance, for a first road agent that is further away from AV 102 than a second road agent that is closer to AV 102, projection system 101 may determine the size of the content item for the first road agent may be bigger than the size of the content item for the second road agent. Moreover, the one or more projection parameters associated with the size of the content item based on the characteristics of the road agent the content item is projected for. The one or more projection devices 103 may project the content item at a size in accordance with the one or more projection parameters associated with the size of the content item.

Referring back to FIG. 1, projection system 101 may provide the content to the one or more projection devices 103. Additionally, and in some instances, projection system 101 may provide the one or more projection parameters associated with the content item to the one or more projection devices 103. Further, the one or more projection devices 103 may project the content item in accordance with the one or more projection parameters.

In some examples, the one or more projection devices 103 may project multiple content items simultaneously. In such examples, the perception data may identify multiple road agents that may be around AV 102. Additionally, the perception data may identify, for each of the multiple road agents, an associated type of road agent. Further, projection system 101 may utilize such perception information to determine and obtain content associated with each of the multiple road agents, as described herein.

In some instances, the one or more projection devices 103 may project each of the multiple content items near a corresponding road agent simultaneously. In such instances, the one or more projection parameters may identify, for each road agent, a position or location the corresponding content item is to be projected onto. For instance, a position or location that is within a predetermined distance threshold of the corresponding road agent. In such instance, for each road agent, projection system 101 may determine such a projection parameter based on corresponding one or more portions of prediction data (e.g., a trajectory or future path) and perception data (e.g., motion characteristics). The one or more projection devices 103 may project the content item for each road agent in accordance with the corresponding projection parameter.

In other examples, projection system 101 may perform operations that adjust one or more projection parameters of one or more content items projected by the one or more projection devices 103. In such examples, projection system 101 may utilize one or more projection criteria to determine whether the one or more content items is legible on the surface that the one or more content items is projected on. In some instances, the one or more projection criteria may include a projection criterion associated with a minimum difference in brightness between the one or more content items and the surface the one or more content items is projected on (herein described as the “minimum color contrast threshold”). In such instances, the minimum color contrast threshold may be represented by a value. In other instances, the one or more projection criteria may include a projection criterion associated with a minimum distance threshold between the projected content item and the associated road agent.

Additionally, projection system 101 may adjust one or more projection parameters of one or more content items projected by the one or more projection devices 103 based on perception data of the one or more content items. For example, perception stack 112 may obtain sensor data, including one or more images of an environment that AV 102 is in, including the projected one or more content items and the surface that the one or more content items is projected on. Additionally, perception stack 112 may process sensor data utilizing one or more trained artificial intelligence or machine learning (AI/ML) processes to identify the one or more content items and the surface that the one or more content items is projected on. Examples of one or more trained AI/ML processes that are associated with object detection within one or more images includes a convolutional neural network type model (e.g., region-based convolutional neural networks (R-CNN)), fast R-CNN, you only look once (YOLO), EfficientNet, Transformers, Residual Networks, Single Shot MultiBox Detector, etc.). The trained AI/ML process, when applied to the sensor data, may detect, or identify the one or more content items and the surface that the one or more content items is projected on. Based on the application of the trained AI/ML process to the sensor data, perception stack 112 may generate object data that identifies the one or more content items and the surface that the one or more content items is projected on.

In some instances, the object data may include one or more portions of sensor data corresponding to each of the one or more content items and the surface. Additionally, based on the object data, projection system 101 may determine a level of brightness or light intensity for the one or more content items. Moreover, based on the object data, projection system 101 may determine a level of brightness or light intensity for the surface that the one or more content items are projected on. Projection system 101 may determine whether the one or more content items is legible based on a comparison of the level of brightness or light intensity between the one or more content items, the surface and the one or more projection criteria (e.g., projection criterion associated with a minimum difference in brightness between the one or more content items and the surface the one or more content items is projected on). Further, projection system 101 may adjust the one or more projection parameters of one or more content items projected by the one or more projection devices 103 based on whether the one or more content items are legible. As such, projection system 101 may provide the adjusted one or more projection parameters to the one or more projection devices 103. The one or more projection devices 103 may project the one or more content items in accordance with the adjusted one or more projection parameters instead of the one or more projection parameters that projection system 101 initially provided.

In various instances, projection system 101 may repeat the operations that adjust the one or more projection parameters of one or more content items projected by the one or more projection devices 103 until one or more projection criteria are met. For instance, following the example above, projection system 101 may continuously or periodically receive object data. Additionally, projection system 101 may adjust the one or more projection parameters associated with a brightness or level of light intensity of the projected one or more content items until the determined level of brightness or light intensity for the one or more content items satisfies the one or more projection criteria (e.g., the level of brightness or light intensity between the one or more content items and the surface meets the minimum difference in brightness).

In various examples, the AV 102 can navigate roadways without a human driver based on sensor signals generated by multiple sensor systems 104, 106, and 108. Additionally, the AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104, 106, 108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104, 106, 108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Control stack 122 can manage the operation of the vehicle propulsion system 130, the braking system 132, the steering system 134, the safety system 136, and the cabin system 138. The control stack 122 can receive sensor signals from the sensor systems 104, 106, 108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

AV operational database 124 can store raw AV data generated by the sensor systems 104, 106, 108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104, 106, 108, roadside assistance requests, software updates, ride-hailing/ridesharing pick-up, and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data.

Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

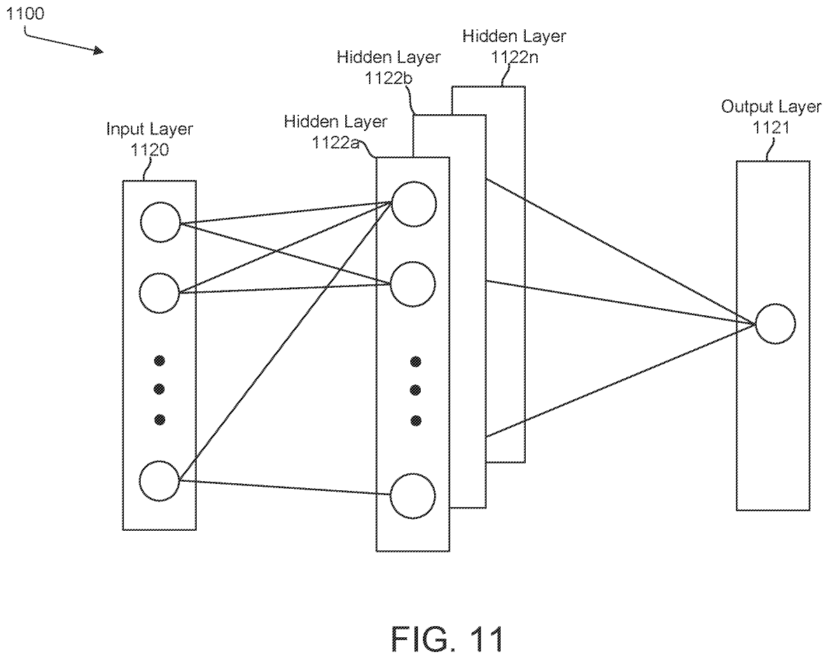

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the client application 172 to enable passengers to view the AV 102 in transit en route to a pick-up or drop-off location, and so on.

[Include this paragraph if applicable] While the AV 102, the local computing device 110, and the AV environment 100 are shown to include certain systems and components, one of ordinary skill will appreciate that the AV 102, the local computing device 110, and/or the AV environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 11.

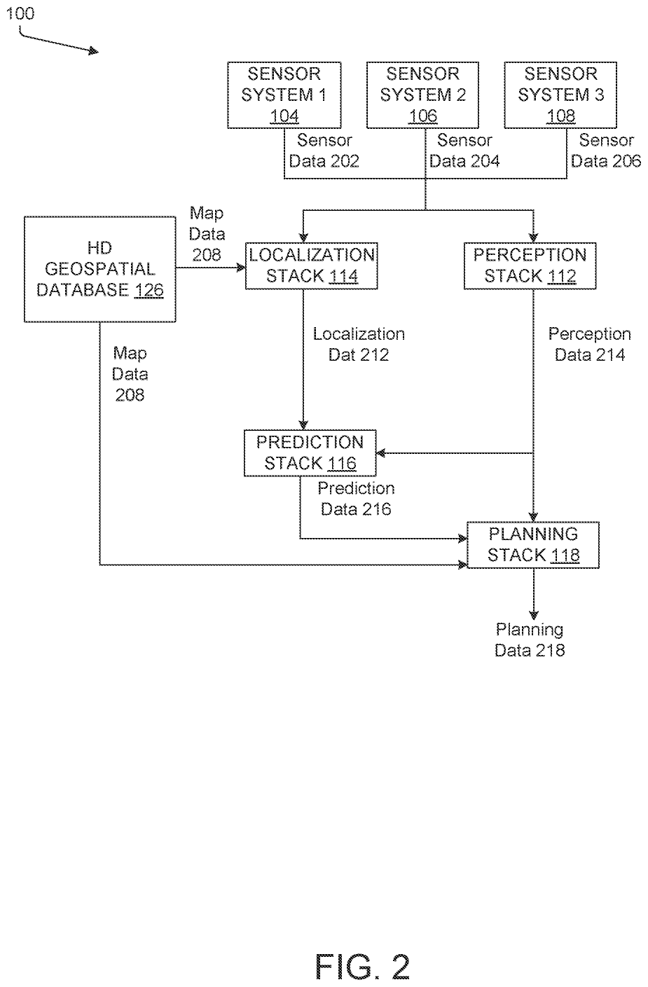

FIGS. 2-4 illustrate portions of AV environment 100, in accordance with some exemplary embodiments. As described herein, projection system 101 may utilize planning data, such as planning data 218, to determine and obtain one or more content items that one or more projection devices 103 may project. Referring to FIG. 2, planning data 218 may be based on sensor data, such as sensor data 202, 204 and/or 206. Additionally, as illustrated in FIG. 2, planning data 218 may be based on perception data 214, localization data 212 and prediction data 216 and perception data 214, localization data 212 and prediction data 216 may be based on sensor data 202, sensor data 204 and/or sensor data 206.

For example, one or more of multiple sensor systems 104, 106 and/or 108, may generate sensor data relating to an environment that AV 102 is in. As described herein, the sensor data 202, sensor data 204 and/or sensor data 206 may be associated with and characterize one or more road agents. For instance, sensor system 106 may be a LIDAR system and sensor data generated by sensor system 106 may include a set of data points in a three-dimensional coordinate system. Additionally, the set of data points may be a diagrammatic representation of an environment that AV 102 may be in. Moreover, subsets of the set of data points may each correspond to one or more objects, such as road agents, that AV 102 has encountered or is encountering. Further, each data point of each subset of the data points may represent a single spatial measurement on the surface of an object included in the corresponding area, such as a pedestrian that AV 102 has encountered or is encountering.

Additionally, one or more of the multiple sensor systems 104, 106 and/or 108 may provide the sensor data 202, sensor data 204 and/or sensor data 206 to localization stack 114. As described herein, localization stack 114 may generate localization data 212 based on sensor data 202, sensor data 204 and/or sensor data 206. For instance, sensor data 202, sensor data 204 and/or sensor data 206 may be generated from GPS, IMUs, cameras, LIDAR, RADAR, ultrasonic sensors. Additionally, localization data 212 may indicate a location and/or pose of AV 102. As described herein, the location of AV 102 may be the current location of AV 102, while the pose of AV 102 may be the position and orientation of AV 102. In some instances, localization data 212 may be further based on map data 208. Additionally, map data 208 may include HD map data. In such instances, localization stack 114 may compare sensor data 202, sensor data 204 and/or sensor data 206 captured in real-time by one or more of the multiple sensor systems 104, 106 and/or 108 to the HD map data of map data 208 to determine its precise (e.g., accurate to the order of a few centimeters or less) position and orientation of AV 102.

Moreover, the one or more of the multiple sensor systems 104, 106 and/or 108 may provide sensor data 202, sensor data 204 and/or sensor data 206 to perception stack 112. Perception stack 112 may generate perception data 210 based on sensor data 202, sensor data 204 and/or sensor data 206. For instance, sensor data 202, sensor data 204 and/or sensor data 206 may be generated from cameras, LIDAR sensors, infrared sensors, microphones, ultrasonic sensors, RADAR, pressure sensors, force sensors, impact sensors. As described herein, perception data 210 may be based on localization data 212 generated and provided by localization stack 114. Additionally, perception data 210 may identify and classify objects, such as road agents, around AV 102 based on sensor data 202, sensor data 204 and/or sensor data 206. Further, perception data 210 may include information characterizing, for each identified object, the free space around AV 102 based on localization data 212 and sensor data 202, sensor data 204 and/or sensor data 206.

By way of example, perception stack 112 may process sensor data 202, sensor data 204 and/or sensor data 206 to identify one or more objects in sensor data 202, sensor data 204 and/or sensor data 206. The trained AI/ML process, when applied to sensor data 202, sensor data 204 and/or sensor data 206 may detect or identify one or more objects. For instance, sensor data 202 may be generated by a light detection and ranging sensor. Additionally, sensor data 202 may include a set of data points in a three-dimensional coordinate system and the set of data points may be a diagrammatic representation of an environment that AV 102 is in. Moreover, perception stack 112 may apply the trained AI/ML process to sensor data 202 to identify one or more objects in the environment that AV 102 is in. Further, based on one or more characteristics or attributes of portions of sensor data 202 corresponding to each of the one or more objects, the trained AI/ML process may classify each of the one or more objects, such as a road agent (e.g., drivers operating other vehicles, pedestrians, and cyclist) and determine one or more attributes associated with each of the one or more objects, such as a description of a pose of the object (e.g., the orientation or heading of the object), a kinematic of the object (information about the object's movement or motion characteristics). In some instances, the trained AI/ML process may further determine a for each identified object, the free space around AV 102 based on localization data 212 and the sensor data, such as sensor data 202. Based on the application of the trained AI/ML process to sensor data 202, perception stack 112 may generate perception data 214 as described herein. In some instances, perception data 214 may include portions of sensor data associated with the identified objects, such as portions of sensor data 202.

Further, prediction stack 116 may obtain localization data 212 from localization stack 114 and perception data 214 from perception stack 112. As described herein, prediction stack 116 may generate prediction data 216 based on localization data 212 and perception data 214. Additionally, prediction data 216 may identify and characterize, for each object identified in perception data 214, a predicted trajectory and/or future path for the object. In some instances, prediction data 216 may identify and characterize, for each object identified in the perception information, multiple future paths for the object and/or trajectories. In such instances, prediction data 216, may include, for each predicted future path and/or trajectory of each object identified in perception data 214, a likelihood the object may follow the predicted future path and/or trajectory. Additionally, for each predicted path, prediction data 216 may include a range of points along the path corresponding to a predicted location of the object along the path at future time intervals along with an expected error value for each of the points that indicates a probabilistic deviation from that point.

By way of example, prediction stack 116 may apply a trained AI/ML process to localization data 212 and perception data 214 to identify and characterize, for each object identified in perception data 214, a predicted trajectory and/or future path for the object relative to the location and pose of AV 102. In some instances, the trained AI/ML process may utilize portions of sensor data, such as sensor data 202, included in perception data 214 to determine the corresponding motion characteristic of the objects identified in perception data 214. Additionally, the trained AI/ML process may determine, for each object identified in perception data 214, multiple future paths for the object and/or trajectories and a likelihood the object may follow each of the multiple predicted future paths and/or trajectories. Moreover, based on the application of the trained AI/ML process to localization data 212 and perception data 214, prediction stack 116 may generate prediction data 216. In some instances, prediction data 216 may include, for each multiple future path and/or trajectories of each object identified in perception data 214, a range of points along each future path corresponding to a predicted location of the object along the path at future time intervals along with an expected error value for each of the points that indicates a probabilistic deviation from that point.

Referring back to FIG. 2, planning stack 118 may obtain prediction data 216 from prediction stack 116 and perception data 214 from perception stack 112. As described herein, planning stack 118 may generate planning data 218 based on prediction data 216 and perception data 214. Additionally, planning data 218 may identify a set of one or more mechanical operations or maneuvers that AV 102 may perform. For example, planning stack 118 may determine multiple sets of one or more mechanical operations or maneuvers that AV 102 can perform based on prediction data 216 and perception data 214 (e.g., location, speed, and direction of the AV 102, geospatial data, data regarding objects, such as road agents, sharing the road with the AV 102 or certain events occurring during the trip, such as emergency vehicle blaring a siren, intersections, occluded areas, street closures for construction or street repairs, double-parked cars, traffic rules and other safety standards or practices for the road, user input, and other relevant data). Examples of the one or more mechanical operations includes go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; and decelerate until completely stopped and reverse. Moreover, planning stack 118 may select the best one of the multiple sets of one or more mechanical operations or maneuvers that AV 102 can perform to meet changing road conditions and events. Further, planning stack 118 may generate planning data 218 that identifies the selected set of one or more mechanical operations or maneuvers.

Further planning data 218 may include one or more portions of perception data 214 and/or prediction data 216 associated with one or more road agents in the environment that AV 102 is in. For example, the one or more portions of planning data 218 may include, for each object identified as a road agent (e.g., a vehicle, pedestrian, cyclist, etc.), information characterizing one or more associated attributes, such as a description of a pose of the object, a kinematic of the object, and a tracked path of the object. Additionally, the one or more portions of planning data 218 may include, for each object identified as a road agent (e.g., a vehicle, pedestrian, cyclist, etc.), information characterizing a predicted trajectory and/or future path for the object relative to the location and pose of AV 102.

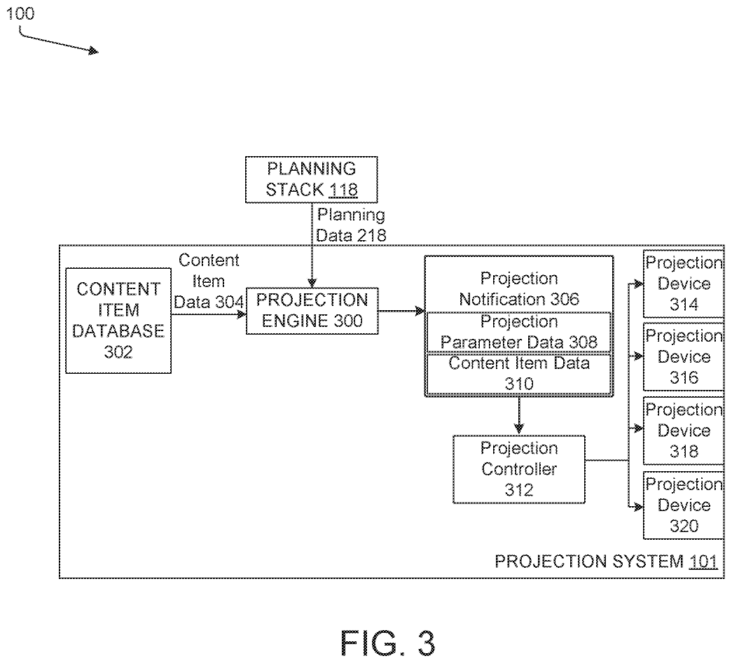

Referring to FIG. 3, planning stack 118 may provide planning data 218 to projection system 101. Additionally, projection system 101 may determine and obtain one or more content items to be projected by one or more projection devices 103 based on planning data 218. As illustrated in FIG. 3, one or more processors of local computing device 110 may execute projection engine 300 of projection system 101. Executed projection engine 300 may obtain planning data 218 and based on planning data 218, executed projection engine 300 may obtain a corresponding content item 304 from content item database 302. As described herein, the content items stored in the content item database may each be associated with or correspond to one or more mechanical operations or maneuvers that AV 102 may perform. Additionally, each of the content items may include data identifying the one or more mechanical operations or maneuvers.

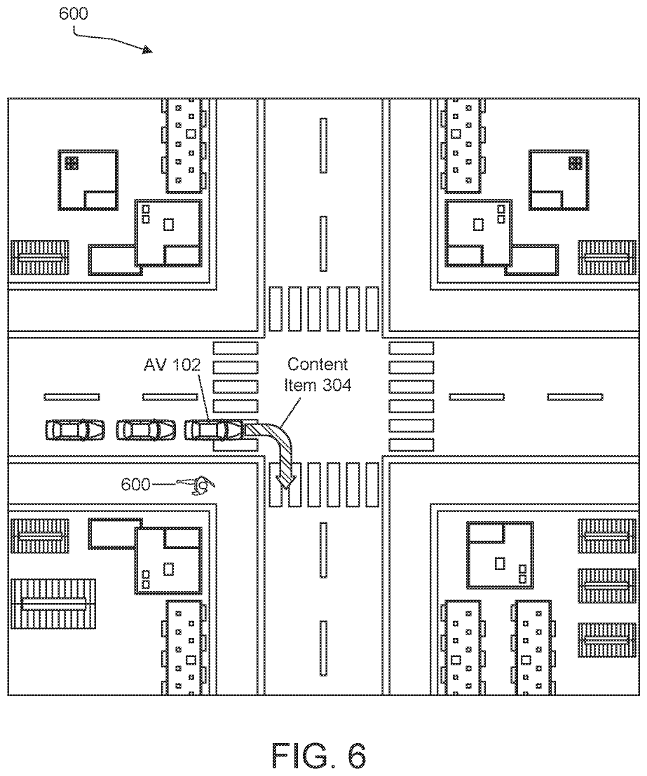

By way of example and as illustrated in FIG. 6, executed projection engine 300 may determine that AV 102 is to perform a right turn at the upcoming intersection based on planning data 218. Additionally, executed projection engine 300 may access content item database 302 and determine which content item stored in content item database 302 is associated with the right turn maneuver characterized in planning data 218. For instance, executed projection engine 300 may identify content item 304 that includes data identifying the mechanical operation or maneuver that matches the mechanical operation or maneuver characterized in planning data 218—the right arrow content item illustrated in FIG. 6. Moreover, executed projection engine 300 may obtain the identified content item that includes data identifying the right turn maneuver characterized in planning data 218, such as content item 304 (e.g., a right arrow). Further, the one or more projection devices 103 may perform operations that project the identified content item, as described herein.

In some examples, executed projection engine 300 may utilize one or more portions of perception data 214 associated with one or more road agents in the environment that AV 102 is in (e.g., portions of perception data 214 that identify the type of road agent of each of the one or more road agents) to determine and obtain content items, such as content item 304. In such examples, the each of the content items stored in the content item database 302, such as content item 304, may include data indicating an associated type of road agent. By way of example and as illustrated in FIG. 6, executed projection engine 300 may determine that AV 102 is to perform a right turn at the upcoming intersection based on planning data 218. Additionally, executed projection engine 300 may detect an object, such as object 600 of FIG. 6, based on perception data 214. Moreover, executed projection engine 300 may determine the object is a pedestrian based on portions of perception data 214 corresponding to the object (e.g., data points in a three-dimensional coordinate system indicate that the object is a pedestrian). Based on the determined set of one or more mechanical operations or maneuvers (e.g., right turn at the upcoming intersection) and the road agent type (e.g., the object in front and on the right of AV 102 is a pedestrian), executed projection engine 300 may identify a corresponding content item in content item database 302, such as content item 304. For instance, projection engine 300 may identify content item 304 in content item database 302 that includes data matching the set of one or more mechanical operations or maneuvers (e.g., right turn at the upcoming intersection) determined from planning data 218 and the road agent type (e.g., the pedestrian/object 600 as illustrated in FIG. 6) determined from perception data 214. Further, executed projection engine 300 may obtain the identified content item, such as content item 304, that includes data matching the set of one or more mechanical operations or maneuvers determined from planning data 218 and the road agent type determined from perception data 214.

In some instances, executed projection engine 300 may obtain content items for one or more road agents that are within a predetermined threshold distance from AV 102. In such instances, executed projection engine 300 may utilize perception data 214 to identify one or more objects that are within a predetermined threshold distance from AV 102. Additionally, executed projection engine 300 may determine which of the one or more objects are road agents, based on one or more portions of perception data 214 associated with each of the one or more objects that are within a predetermined threshold distance from AV 102. Moreover, executed projection engine 300 may determine, for each object identified as a road agent, the type of road agent, based on one or more portions of perception data 214 associated with each object identified as a road agent. Further, executed projection engine 300 may access content item database 302 to determine, for each object identified as a road agent, a content item that is associated with a set of one or more mechanical operations or maneuvers characterized in the planning data and the identified road agent type, such as content item 304.

Referring back to FIG. 3, executed projection engine 300 may generate projection parameter data 308 that includes one or more projection parameters. As described herein, one or more projection devices 103 may project content items, such as content item 304, in accordance with the one or more projection parameters of projection parameter data 308. Additionally, executed projection engine 300 may determine the one or more projection parameters to ensure the corresponding content items, such as content item 304, is visible to road agents near AV 102, such as pedestrians, other human drivers, other autonomous vehicles, or bicyclists. In some examples, the one or more projection parameters may identify a position or location the content item, such as content item 304, is to be projected onto by one or more projection devices 103. For example, the position or location may be on a surface, such as a road surface, near AV 102. Additionally, executed projection engine 300 may utilize one or more portions of perception data 214 and one or more portions of prediction data 216 associated with one or more road agents identified in perception data 214 to determine the one or more projection parameters associated with a position or location a corresponding content item is to be projected onto.

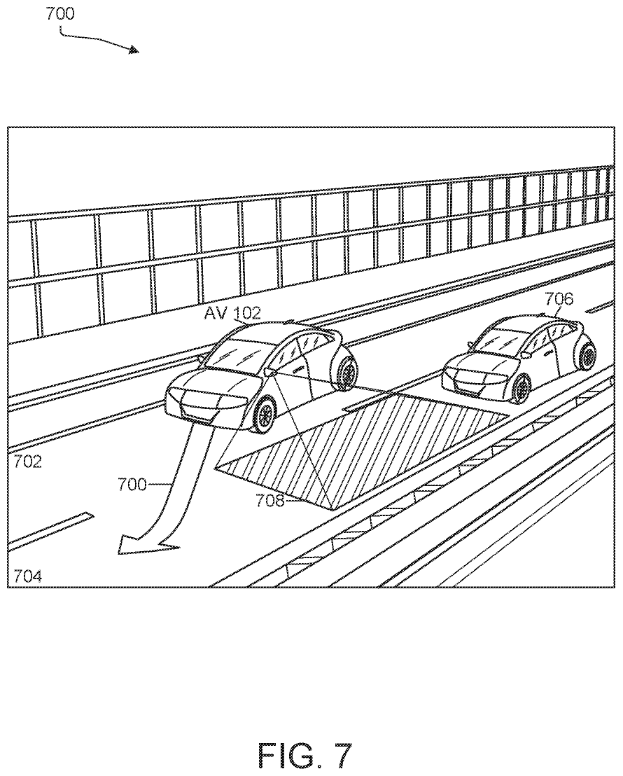

By way of example, executed projection engine 300 may utilize one or more portions of prediction data 216 of one or more road agents identified in perception data 214 to determine a trajectory or future path of each of the one or more road agents. Additionally, executed projection engine 300 may determine which of the one or more road agents would likely affect the set of one or more mechanical operations of maneuvers characterized in planning data 218. For instance, and as illustrated further in FIG. 7, executed projection engine 300 may determine the set of one or more mechanical operations of maneuvers characterized in planning data 218 is associated with changing lanes (as represented by arrow 700) from first lane 702 to second lane 704 where second lane 704 includes vehicle 706. Additionally, executed projection engine 300 may determine vehicle 706 is traveling at a rate of speed and at a future path that may collide with AV 102 during the lane change, based on planning data 218 and portions of perception data 214 and/or prediction data 216 associated with the vehicle. In some instances, executed projection engine 300 may determine the likelihood of collision between the vehicle and AV 102 during the lane change based on planning data 218 and portions of perception data 214 and/or prediction data 216 associated with vehicle 706. Additionally, executed projection engine 300 may determine vehicle 706 would likely affect the lane change upon determining the likelihood of collision is greater than or equal to a predetermined likelihood of collision threshold.

Moreover, for each of the one or more road agents that likely affect the set of one or more mechanical operations or maneuvers characterized in planning data 218, executed projection engine 300 may determine a position/location on a surface, such as the road surface, to project the content item, based on the future path and/or trajectory of such road agents. For instance, following the example illustrated in FIG. 7 and based on portions of prediction data 216 associated with vehicle 706, executed projection engine 300 may further determine a trajectory or future path of vehicle 706. As an example, executed projection engine 300 may detect and determine that the vehicle 706 is traveling parallel to AV 102 in second lane 704 and may affect the lane change of AV 102. Based on the trajectory or future path of vehicle 706, executed projection engine 300 may determine one or more projection parameters that give vehicle 706 an opportunity to see content item 708 for vehicle 706 when projected from the one or more projection devices 103, such as in front of the vehicle 706.

In other examples, the one or more projection parameters may indicate a brightness or level of light intensity for projecting a content item, such as content item 304. In such examples, one or more projection devices 103 may project the content item at a level of light intensity or brightness in accordance with such projection parameters. In some instances, the one or more projection parameters associated with a brightness or level of light intensity for the content item may be based on a level of light intensity, color, contrast, and reflection of an environment that AV 102 is in. In such instances, perception data 214 may indicate a light level of an environment that AV 102 is in. Additionally, perception data 214 may be based on sensor data generated by one or more of the multiple sensor systems (e.g., sensor systems 104, 106 and/or 108), such as images of the environment that AV 102 is in. Moreover, perception stack 112 may determine the light intensity (e.g., lumens) of the environment that AV 102 is in, based on perception data 214. Executed projection engine 300 may determine one or more projection parameters that may indicate the brightness or level of light intensity for a content item based on the determined level of light intensity of the environment that AV 102 is in.

Additionally, or alternatively, the one or more projection parameters associated with a brightness or level of light intensity for the content item may be based a color of a surface that the one or more projection devices 103 may project the content item onto, such as a road surface. In some instances, perception data 214 may indicate a color of a surface the one or more projection devices 103 may project the content item onto, such as a road surface. For instance, based on the parameters indicating a position/location that content item 304 may be projected on, perception stack 112 may determine a corresponding surface that content item 304 may be projected on based on sensor data (e.g., sensor data 202, sensor data 204 and/or sensor data 206) generated by one or more of multiple sensor systems 104, 106 and/or 108, such as images of the environment that AV 102 is in. Additionally, perception stack 112 may determine the color of the identified surface based on the sensor data. Further, executed projection engine 300 may determine the one or more projection parameters that may indicate the brightness or level of light intensity for a content item, such as content item 304, based on the determined color of the identified surface the content item may be projected on by the one or more projection devices 103.

Additionally, and in other instances, projection system 101 may take into account the type of surface that a content item may be projected on when determining the one or more projection parameters associated with a brightness or level of light intensity for the content item. Additionally, perception data 214 may indicate the type of surface that the content item may be projected on. In such instances, perception stack 112 may utilize a trained AI/ML process that identifies the type of surface that the content item may be projected on. For instance, perception stack 112 may apply the trained AI/ML process to sensor data (sensor data 202, sensor data 204 and/or sensor data 206) associated with a surface around AV 102. The application of the trained AI/ML process to the sensor data may cause perception stack 112 to generate data that identifies a type of surface that the content item may be projected on, such as asphalt or concrete. Based on such data, projection system 101 may determine the type of surface that the content item may be projected on. Further, projection system 101 may determine one or more projection parameters, such as the color and brightness level, for the content item. The one or more projection devices 103 may project the content item, such as content item 304, in accordance with the one or more projection parameters.

In various examples, the one or more projection parameters may indicate a color of a content item, such as content item 304, to be projected by the one or more projection devices 103. In such instances, executed projection engine 300 may determine the one or more projection parameters associated with a color based on perception data 214. Additionally, perception data 214 may indicate a color of a surface the one or more projection devices 103 may project the content item onto, such as a road surface. As described herein, perception stack 112 may generate perception data 214 indicating the color of the surface, based on sensor data (e.g., sensor data 202, sensor data 204 and/or sensor data 206) generated by one or more of the multiple sensor systems 104, 106 and/or 108), such as images of the environment that AV 102 is in.

Referring back to FIG. 3, executed projection engine 300 may provide the one or more projection parameters along with the obtained content data to one or more projection devices 103. For example, as illustrated in FIG. 3, executed projection engine 300 may generate projection notification 306 and package within one or more portions of projection notification 306 portions of projection parameter data 308 and associated content item 304. In some instances, and as illustrated in FIG. 3, projection system 101 may include projection controller 312. In such instances, projection controller 312 may manage the one or more projection devices 103. For instance, projection controller 312 may receive projection notification 306 and generate data to one or more projection devices 103 to cause the one or more projection devices 103 to project content item 304 in accordance with the one or more projection parameters included in projection parameter data 308.

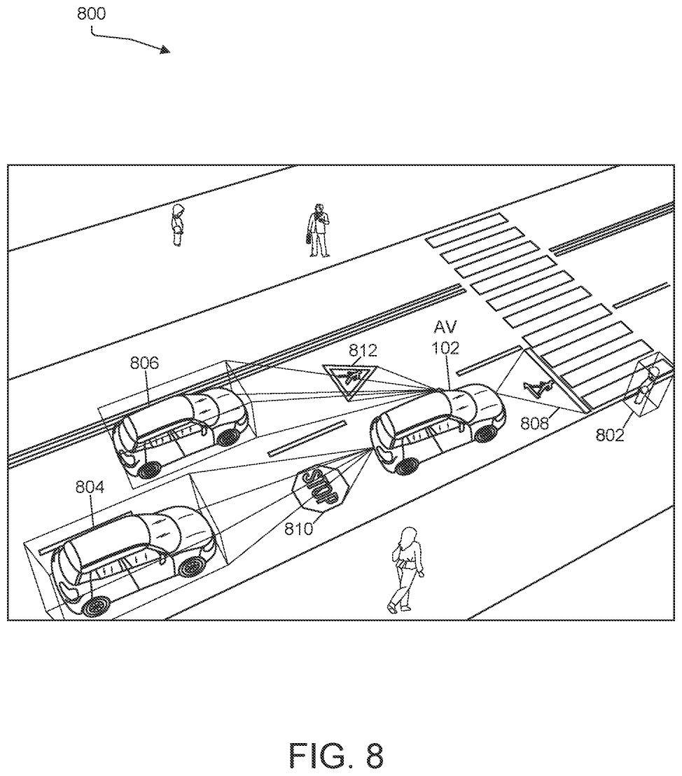

In some examples, the one or more projection devices 103 may project multiple content items simultaneously, including content item 304. In such examples, perception data 214 may identify multiple objects that may be around AV 102. Additionally, perception data 214 may identify, for one or more of the multiple road agents, an associated type of road agent. For example, as illustrated in FIG. 8, perception data 214 may be associated with environment 800 that AV 102 is in. Additionally, perception data 214 may identify object 802, object 804 and object 806. Moreover, perception data 214 may identify, for each of the identified objects an associated type of road agent, such as for object 802 a pedestrian, for object 804 a first vehicle and for object 806 a second vehicle.

Further, executed projection engine 300 may utilize perception data 214 to determine and obtain a content item associated with each of the multiple road agents from content item database 302. For example, and referring back to the example of FIG. 8, executed projection engine 300 may determine that AV 102 is to perform one or more mechanical operations or maneuvers that cause AV 102 to slow down and stop at a particular location based on planning data 218. Additionally, executed projection engine 300 may detect object 802, object 804 and object 806 around AV 102 based on perception data 214. Moreover, executed projection engine 300 may determine object 802 is a pedestrian, object 804 is a first vehicle, and object 805 is a second vehicle based on portions of perception data 214 corresponding to each of the objects. For instance, executed projection engine 300 may determine the object 802 is a pedestrian based on data points in a three-dimensional coordinate system included in perception data 214 that indicates object 802 is a pedestrian. Additionally, executed projection engine 300 may determine the object 804 is a first vehicle based on data points in a three-dimensional coordinate system included in perception data 214 that indicates object 804 is a vehicle. Further, executed projection engine 300 may determine the object 806 is a second vehicle based on data points in a three-dimensional coordinate system included in perception data 214 that indicates object 806 is a vehicle.

Moreover, executed projection engine 300 may access content item database 302 to identify a content item associated with the set of one or more mechanical operations or maneuvers and each of the identified road agent types. For example, and referring back to the example of FIG. 8, executed projection engine 300 may access content item database 302 to identify a content item, such as content item 808, associated with the pedestrian and the set of one or more mechanical operations or maneuvers determined from planning data 218, content item 810 associated with the first vehicle and the set of one or more mechanical operations or maneuvers determined from planning data 218, and content item 812 associated with the second vehicle and the set of one or more mechanical operations or maneuvers determined from planning data 218. Further, executed projection engine 300 may provide the identified content items, such as content item 808, content item 810 and content item 812, to projection controller 312. Projection controller 312 may cause the one or more projection devices 103 to simultaneously project each of the identified content items onto one or more surfaces outside of AV 102.

In some instances, executed projection engine 300, as described herein, may generate projection parameter data 308 for each of the identified content items, based on one or more portions of perception data 214 and/or prediction data 216 corresponding to each of the multiple objects identified in perception data 214. In such instances, projection controller 312 may cause the one or more projection devices 103 to simultaneously project each of the identified content items in accordance with corresponding projection parameter data 308.

For instance, and referring back to FIG. 8, the projection parameter associated with each of content item 808, content item 810 and content item 810 may be based on one or more portions of perception data 214 and/or prediction data 216 corresponding to each of object 802, object 804 and object 806 respectively. In such an instance, the projection parameter for content item 808 may indicate a position/location to project content item 808 that is near object 802, and the projection parameter for each of content item 810 and content item 812 may also indicate a position/location to project each of content item 810 and content item 812 respectively (e.g., in front of and near the respective objects-object 804 and object 806 respectively). By way of example, executed projection engine 300 may determine motion characteristics, a future path and/or trajectory for each of object 802, object 804 and object 806, based corresponding one or more portions of perception data 214 and prediction data 216. Additionally, for object 802 and based on the motion characteristics, a future path and/or trajectory of the pedestrian of object 802, executed projection engine 300 may determine a position/location on a surface, such as the road surface, to project content item 808 onto. The position or location may be within a predetermined threshold distance of a predicted future location of the object 802, the pedestrian. Moreover, for object 804 and based on the motion characteristics, a future path and/or trajectory of object 804, executed projection engine 300 may determine a position/location on a surface, such as the road surface, to project the content item 810 onto. The position or location may be within a predetermined threshold distance of a predicted future location of the object 804, the vehicle. Further, for object 806 and based on the motion characteristics, a future path and/or trajectory of object 806, executed projection engine 300 may determine a position/location on a surface, such as the road surface, to project the content item 812 onto. The position or location may be within a predetermined threshold distance of a predicted future location of the object 806, the other vehicle. As such, executed projection engine 300 may generate a first projection parameter characterizing a position or location for content item 808 to be projected onto, a second projection parameter characterizing the position or location for content item 810 to be projected onto, and a third projection parameter characterizing the position or location for content item 812 to be projected onto. In some instances, executed projection engine 300 may provide the first projection parameter along with content item 808, the second projection parameter along with content item 810, and the third projection parameter along with content item 812 to projection controller 312. Projection controller 312 may cause the one or more projection devices 103, such as projection device 314, projection device 316, projection device 318 and/or projection device 320, to simultaneously project content item 808, content item 810, and content item 812 in accordance with the first projection parameter, the second projection parameter, and the third projection parameter respectively.

As described herein, planning data 218 may include one or more portions of perception data 214 associated with one or more road agents in the environment that AV 102 is in and/or one or more portions of prediction data 216 associated with the one or more road agents. In some instances, executed projection engine 300 may separately obtain planning data 218 from projection system 101 and the one or more portions of perception data 214 from perception stack 112 and/or the one or more portions of prediction data 216 from perception stack 112.

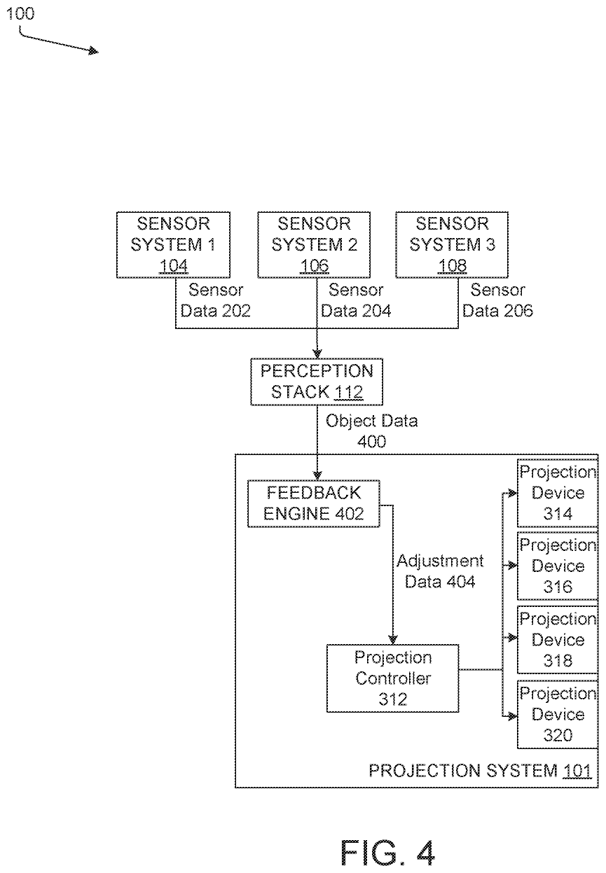

Referring to FIG. 4, projection system 101 may adjust one or more projection parameters of one or more content items projected by one or more projection devices 103. Additionally, projection system 101 may utilize one or more projection criteria to determine whether the one or more content items is legible on a surface that the one or more content items is projected on. As described herein, the one or more projection criteria may include a projection criterion associated with a minimum difference in brightness between the one or more content items and the surface the one or more content items is projected on (herein described as the “minimum color contrast threshold”). In some instances, the minimum color contrast threshold may be represented by a value.

For example, one or more of the multiple sensor systems 104, 106 and/or 108 of AV 102, may generate sensor data 202, sensor data 204 and/or sensor data 206, respectively. In such example, the sensor data of the one or more of multiple sensor systems 104, 106 and/or 108 (e.g., sensor data 202, sensor data 204 and/or sensor data 206) may include one or more images of an environment that AV 102 is in, including the projected one or more content items and the surface that the one or more content items is projected on. As illustrated in FIG. 4, perception stack 112 may obtain the sensor data (e.g., sensor data 202, sensor data 204 and/or sensor data 206) from one or more of the multiple sensor systems 104, 106 and/or 108. Additionally, perception stack 112 may process the sensor data utilizing one or more trained artificial intelligence or machine learning (AI/ML) processes to identify the one or more content items and the surface that the one or more content items is projected on. Examples of one or more trained AI/ML processes that are associated with object detection within one or more images includes a convolutional neural network type model (e.g., region-based convolutional neural networks (R-CNN)), fast R-CNN, and you only look once (YOLO). The trained AI/ML process, when applied to the sensor data, may detect or identify the one or more content items and the surface that the one or more content items is projected on. Based on the application of the trained AI/ML process to the sensor data, perception stack 112 may generate object data 400. As described herein, object data 400 may identify the one or more content items and the surface that the one or more content items is projected on. In some instances, object data 400 may include one or more portions of sensor data (e.g., sensor data 202, sensor data 204 and/or sensor data 206) corresponding to each of the one or more content items and the surface.

Additionally, perception stack 112 may provide object data 400 to feedback engine 402. Moreover, one or more processors of local computing device 110 may execute feedback engine 402 of projection system 101. Executed feedback engine 402 may determine a level of brightness or light intensity for the one or more content items based on portions of the sensor data corresponding to the one or more content items. Further, executed feedback engine 402 may determine a level of brightness or light intensity for the surface that the one or more content items is projected on based on portions of the sensor data corresponding to the surface that the one or more content items is projected on. In some instances, the level of brightness or light intensity may be represented by a value. Based on the determined level of brightness of the one or more content items and the determined level of brightness of the surface, executed feedback engine 402 may determine a difference between the determined level of brightness of the one or more content items and the determined level of brightness of the surface. In some instances, executed feedback engine 402 may determine the difference by comparing the determined level of brightness of the one or more content items and the determined level of brightness of the surface.

In some examples, executed feedback engine 402 may determine whether the determined difference meets the minimum color contrast threshold. In some instances, executed feedback engine 402 may determine the value of the determined difference is less than the value of the minimum color contrast threshold. In such instances, executed feedback engine 402 may determine the determined difference does not meet the minimum color contrast threshold. Additionally, based on such determinations, executed feedback engine 402 may adjust one or more projection parameters of one or more content items projected by the one or more projection devices 103. Moreover, executed feedback engine 402 may generate adjustment data 404. As described herein, adjustment data 404 may include the adjusted one or more projection parameters. Further, executed feedback engine 402 may provide adjustment data 404 to projection controller 312. Projection controller 312 may cause the one or more projection devices 103 to project the one or more content items in accordance with the adjusted one or more project parameters of adjustment data 404. The one or more projection devices 103 may project the one or more content items in accordance with the adjusted one or more projection parameters instead of the one or more projection parameters executed projection engine 300 initially provided to projection controller 312. As described herein, AV 102, such as perception stack 112 and executed feedback engine 402 may repeat such steps until the determined difference meets the minimum color contrast threshold. In other instances, executed feedback engine 402 may determine the value of the determined difference is greater than or equal to the value of the minimum color contrast threshold. In such instances, executed feedback engine 402 may determine the determined difference does meet the minimum color contrast threshold. Additionally, the one or more projection devices 103 may continue to project the one or more content items without any adjustments.

In other instances, projection controller 312 may adjust one or more electrical or mechanical components or aspects of one or more of projection devices 103 (e.g., focal length or angel of the projection component of the corresponding projection device 103) based on adjustment data 404. The adjustments to the electrical or mechanical components or aspects to the one or more projection devices 103 may adjust the visibility of the one or more content items (e.g., location and position of where the content item is projected, the brightness level, the color, etc.).

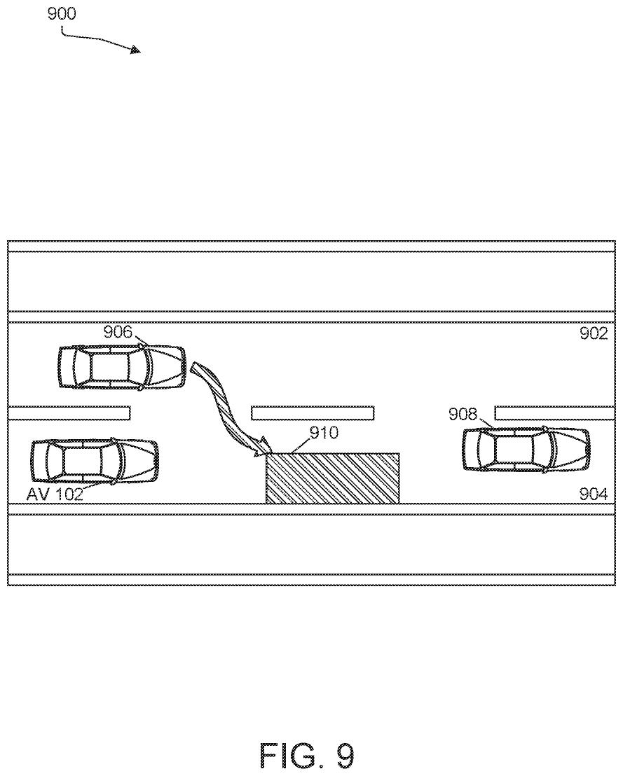

In other examples, AV 102 may determine one or more mechanical operations or maneuvers that a second vehicle, similar to AV 102, may perform based on one or more content items the second vehicle has projected. In such examples, the second vehicle, may include one or more aspects similar to AV 102 to perform operations to project one or more content items, as described herein similarly with AV 102. Additionally, AV 102 may determine one or more mechanical operations or maneuvers that the second vehicle may perform based on sensor data that includes one or more images of the one or more content items. For instance, and as illustrated in FIG. 9, environment 900 may include first lane 902, second lane 904 and vehicle 906, vehicle 908 and AV 102. Additionally, vehicle 906 may project content item 910. In such instance, content item 910 may be associated with a set of mechanical operations or maneuvers for a lane change from first lane 902 to second lane 904 that vehicle 906 may perform. As illustrated in FIG. 9, second lane 904 may include AV 102 and vehicle 908. Moreover, AV 102 may determine the set of mechanical operations or maneuvers based on sensor data associated with content item 910.

By way of example, one or more of multiple sensor systems of AV 102, such as sensor system 104, 106 and/or 108, may generate sensor data (e.g., sensor data 202, sensor data 204 and/or sensor data 206) of the one or more content items, such as content item 910 of FIG. 9, projected by the second vehicle. In such an example, the sensor data may include one or more images of an environment AV 102 is in, including the projected one or more content items. Additionally, perception stack 112 may process the sensor data utilizing one or more trained artificial intelligence or machine learning (AI/ML) processes to identify the one or more content items. Examples of one or more trained AI/ML processes that are associated with object detection within one or more images includes a convolutional neural network type model (e.g., region-based convolutional neural networks (R-CNN)), fast R-CNN, and you only look once (YOLO). The trained AI/ML process, when applied to the sensor data, may detect or identify the one or more content items. Based on the application of the trained AI/ML process to the sensor data, perception stack 112 may generate processed sensor data that identifies the one or more content items. Additionally, projection system 101 may determine a set of one or more mechanical operations or maneuvers that the second vehicle, such as vehicle 906 of FIG. 9, may perform based on the processed sensor data. For instance, projection system 101 may access the content item database, such as content item database 302, and identify a content item that includes features that match the features of the one or more content items identified in the processed sensor data (e.g., content item 910 of FIG. 9). Additionally, projection system 101 may determine one or more mechanical operations or maneuvers the vehicle may perform based on data included in the matching content item identifying an associated set of one or more mechanical operations or maneuvers. For instance, and referring to FIG. 9, projection system 101 of AV 102 may identify a matching content item stored in the content item database. The matching content item may include data identifying the set of one or more mechanical operations or maneuvers associated with the lane change.

In some instances, AVs that include a projection system similar to projection system 101, may communicate with each other via content item(s) projection. In such instances, each of the AVs may further include multiple sensor systems, such as sensor systems 104, 106 and 108, to generate sensor data (e.g., sensor data 204, sensor data 206 and/or sensor data 208). The sensor data may include one or more images of an environment the corresponding AV is in, including a content item projected by another AV. Additionally, the projection system, similar to projection system 101, of each of the AVs may determine one or more mechanical operations or maneuvers the other vehicle may perform based on one or more portions of the sensor data. Further, each of the AVs may utilize the determined one or more mechanical operations or maneuvers the other vehicle may perform to determine one or more mechanical operations or maneuvers that each of the AVs may perform. As described herein, each of the AVs may further include a content database, similar to the content database of projection system 101. Additionally, similar to the content database of projection system 101, the content database of each of the AVs may store the content database may store one or more content items. Each of the one or more content items may be associated with and include data identifying a set of one or more mechanical operations or maneuvers that each of the one or more AVs may perform.

For example, and as illustrated in FIG. 9, environment 900 may include first lane 902, second lane 904, vehicle 906, vehicle 908 and AV 102. Additionally, vehicle 906 may project content item 910. In such instance, content item 910 may be associated with a set of mechanical operations or maneuvers for a lane change from first lane 902 to second lane 904 that vehicle 906 may perform. As illustrated in FIG. 9, second lane 904 may include AV 102 and vehicle 906. Moreover, projection system 101 of AV 102 may determine that vehicle 906 may perform a lane change into second lane 904 from first lane 902 based on perception data 214 as described herein. Based on the determined set of mechanical operations or maneuvers that vehicle 906 may perform, AV 102 may determine to communicate with vehicle 906 to respond to the projected content item 910.

In some instances, AV 102 may perform safety checks. For instance, based on determining vehicle 906 may perform the lane change, planning stack 118, may utilize perception data 214 to determine whether the space between AV 102 and vehicle 908 is large enough for vehicle 906 to safely fit. In instances, where planning stack 118 determines the space is too small for vehicle 906 to safely fit, planning stack 118 may generate planning data 218 to projection system 101. In such instances, planning data 218 may identify a content item that indicates and is a graphical representation that vehicle 906 should not or cannot perform the lane change. Additionally, projection system 101 may identify and obtain, from content item datastore 302, a content item corresponding to the content item identified in planning data 218. Moreover, projection system 101 may determine one or more projection parameters for the obtained content item and generate projection parameter data including the one or more projection parameters. As described herein, projection system 101 may determine the one or more parameters, such as a parameter associated with the positioning and location of the projection of the content item near vehicle 906, based on one or more portions of perception data 214 and/or prediction data 216 associated with vehicle 906. Projection system 101 may generate a projection notification and package one or more portions of the projection parameter data the obtained content item. Further, projection system 101 may provide the projection notification to projection controller 312. Projection controller 312 may cause one or more projection devices 103 to project the obtained content item in accordance with the one or more projection parameters included in the projection notification, such as projecting the content item near vehicle 906.

As such, a projection system of vehicle 906, similar to projection system 101, may cause vehicle 906 to not perform the lane change based on the content item projected by the one or more projection devices of AV 102. For instance, as described herein, the second vehicle may include one or more sensor systems, such as sensor systems 104, 106 and/or 108. Additionally, the or more sensor systems may generate sensor data, similar to sensor data 202, sensor data 204 and/or sensor data 206, of the content item. The sensor data may include one or more images of an environment the second vehicle is in, including the content item projected by the one or more projection devices of AV 102. Moreover, a perception stack of vehicle 906, like perception stack 112, may process the sensor data utilizing one or more trained artificial intelligence or machine learning (AI/ML) processes to identify the one or more content items. The trained AI/ML process, when applied to the sensor data, may detect or identify the content item projected by the one or more projection devices 103. Based on the application of the trained AI/ML process to the sensor data, the perception stack of vehicle 906 may generate processed sensor data that identifies the content item. Further, a projection system of vehicle 906, similar to projection system 101, may access a content item database of vehicle 906, similar to content item database 302, and identify a content item that matches the content item identified in the processed sensor data. Based on the identified content item in the content item database, the projection system of vehicle 906 may determine the identified content item may indicate not performing the lane change. Based on such determinations, vehicle 906 may not perform the lane change. For instance, the projection system of vehicle 906 may generate an instruction that indicates vehicle 906 should not perform the lane change based on such determinations. Further, the projection system of vehicle 906 may provide the instruction to a planning stack, similar to planning stack 118 of AV 102. The planning stack may utilize the instruction to cause vehicle 906, such as a control stack similar to control stack 122 of AV 102, to not perform the lane change.

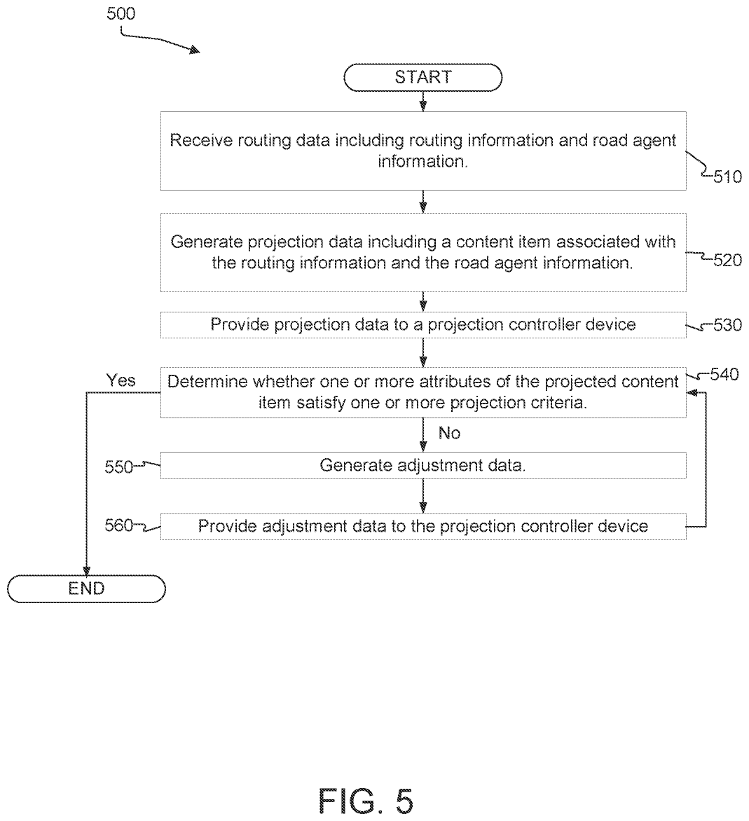

FIG. 5 is a flow chart of an exemplary process 500 for projecting one or more content items by one or more projection devices 103 of AV 102. In some instances, one or more components of AV environment 100 may perform all or a portion of the steps of exemplary process 500, which include but are not limited to receiving routing data including routing information and road agent information, generating projection data including a content item associated with the routing information and the road agent information, and providing projection data to a projection controller device.

Referring to FIG. 5, projection system 101 may receive routing data including routing information and road agent information (e.g., step 510). For example, as illustrated in FIG. 3, executed projection engine 300 may obtain routing or planning data, such as planning data 218 generated from planning stack 118. As described herein, the routing or planning data 218 may include information characterizing a set of one or more mechanical operations or maneuvers AV 102 may safely and efficiently perform in its environment, such as traveling from a first location to a second location. Additionally, the routing or planning data 218 may be based on perception data 214 and prediction data 216.

Moreover, the road agent information may be associated with one or more road agents within a predetermined distance threshold of AV 102. In some instance, the road agent information may include one or more portions of perception data 214 associated with each of the one or more road agents within a predetermined distance threshold of AV 102. Additionally, or alternatively, the road agent information may include one or more portions of prediction data 216 associated with each of the one or more road agents within a predetermined distance threshold of AV 102. In some instances, executed projection engine 300 may separately obtain the routing or planning data 218 from planning stack 118 and the one or more portions of perception data 214 from perception stack 112 and/or the one or more portions of prediction data 216 from prediction stack 116.

Referring to FIG. 5, projection system 101 may generate projection data including a content item associated with the routing information and the road agent information (e.g., step 520). In some examples, as illustrated in FIG. 3, executed projection engine 300 may obtain a corresponding content item from content item database 302, based on the routing or planning data 218 and the determined road agent type of each of one or more road agents within a threshold distance of AV 102. For example, executed projection engine 300 may access content item database 302 and identify content item 304 that includes data identifying the set of one mechanical operations or maneuvers characterized in routing or planning data 218 and the road agent type of a road agent that is within a predetermine threshold distance from AV 102. Additionally, executed projection engine 300 may obtain the identified content item 304. Further, executed projection engine 300 may generate a projection notification, such as projection notification 306, and package within one or more portions of the projection data, one or more portions of the obtained content item, such as content item 304.

In some examples, executed projection engine 300 may generate projection parameter data for the obtained content item, such as projection parameter data 308 for content item 304. As described herein, one or more projection devices 103 may project content items, such as content item 304, in accordance with the one or more projection parameters of projection parameter data. Additionally, executed projection engine 300 may package within one or more portions of the projection data, one or more portions of the projection parameter data along with the one or more portions of the obtained content item. In some instances, the one or more projection parameters may identify a position or location the content item is to be projected onto by one or more projection devices 103. In other instances, the one or more projection parameters may indicate a brightness or level of light intensity for projecting a content item. In various instances, the one or more projection parameters may indicate a color for the projected content item.

Referring to FIG. 5, projection system 101 may provide projection data to a projection controller device (e.g., step 530). For example, executed projection engine 300 may provide the projection notification, such as projection notification 306, to the projection controller, such as projection controller 312. As described herein, the projection controller, may manage the one or more projection devices 103. For instance, projection controller 312 may receive projection notification 306 and generate data that causes the one or more projection devices 103 to project content item 304 in accordance with the one or more projection parameters included in projection parameter data 308.

Referring to FIG. 5, projection system 101 may determine whether one or more attributes of the projected content item satisfy one or more projection criteria (e.g., step 540). In some examples, executed feedback engine 402 may obtain object data 400. As described herein, object data 400 may be generated by perception stack 112 applying a trained AI/ML process to sensor data, such as sensor data 202, sensor data 204, and/or sensor data 206. Additionally, object data 400 may identify and characterize an object on a surface near AV 102. Further, object data 400 may include one or more portions of sensor data associated with the object and the surface (e.g., one or more images of an object on a surface, such as content item 304). In such examples, executed feedback engine 402 may determine whether the object identified in object data 400 is a content item projected by the one or more projection devices 103.

In some instances, executed feedback engine 402 may parse object data 400 and identify the one or more portions of sensor data associated with the object. Additionally, executed feedback engine 402 may identify or determine one or more features of the object. Moreover, executed feedback engine 402 may access a database, such as content item database 302, to identify a content item that includes features that match the features of the object. In some instances, the database may include data identifying when the content item, such as content item 304, was projected by the one or more projection devices 103. Based on determining the features of the object match the features of a content item stored in the database, such as content item database 302, and/or the content item was projected, executed feedback engine 402 may determine the object is a content item projected by the one or more projection devices 103.

In other examples, executed feedback engine 402 may determine or identify one or more attributes or characteristics of the object based on determining the object is a content item projected by the one or more projection devices 103. In some instances, executed feedback engine 402 may parse object data 400, such as the one or more portions of sensor data associated with the object, to determine one or more attributes or characteristics of the object, such as the level of brightness or light intensity associated with the object, the color of the object, and/or a size of the object. Additionally, executed feedback engine 402 may determine or identify one or more attributes or characteristics of the surface the object is on. In some instances, executed feedback engine 402 may parse object data 400, such as the one or more portions of sensor data associated with the surface, to determine one or more attributes or characteristics of the object, such as the level of brightness or light intensity associated with the object, the color of the object, and/or the type of.

In various examples, executed feedback engine 402 may determine whether the one or more attributes or characteristics of the object satisfy one or more projection criteria, based on the one or more attributes or characteristics of the object, the one or more attributes or characteristics, and the one or more projection criteria. As described herein, and by way of example, the one or more projection criteria may be associated with a difference between the level of brightness or light intensity of the object to the level of brightness or light intensity of the surface. In such instances, executed feedback engine 402 may compare the level of brightness of the object and the level of brightness of the surface and determine a difference between the level of brightness of the object and the level of brightness of the surface (e.g., a value that represents the difference). Additionally, executed feedback engine 402 may compare the difference between the level of brightness of the object and the level of brightness of the surface and a corresponding projection criterion, such as a minimum color contrast threshold (e.g., a value that represents the threshold). Based on the comparison, executed feedback engine 402 may determine whether the difference between the level of brightness of the object and the level of brightness of the surface satisfy the corresponding projection criterion.

In some examples, projection system may determine the one or more attributes of the projected content item satisfies the one or more projection criteria. In such examples, projection system 101 may end the process. In other examples, projection system 101 may determine the one or more attributes of the projected content item does not satisfy the one or more projection criteria. In such examples, and referring to FIG. 5, projection system 101 may generate adjustment data (e.g., step 550). For example, a projection criterion may include a first value that represents a minimum color contrast threshold between the level of brightness of the object and the level of brightness of the surface. Additionally, executed feedback engine 402 may compare the level of brightness of the object and the level of brightness of the surface and determine a difference between the level of brightness of the object and the level of brightness of the surface. Executed feedback engine 402 may determine a second value that represents such a difference. Moreover, executed feedback engine 402 may compare the first value and the second value. Based on the comparison, executed feedback engine 402 may determine the difference between the level of brightness of the object and the level of brightness of the surface do not satisfy the corresponding projection criterion. Further, executed feedback engine 402 may adjust one or more projection parameters, such as the brightness level or level of light intensity, of the corresponding content item, such as content item 304. The adjustments may be based on the difference between the first value and the second value. In some instances, executed feedback engine 402 may generate adjustment data, such as adjustment data 404. As described herein, the adjustment data may include the adjusted one or more projection parameters.

Referring to FIG. 5, projection system 101 may provide adjustment data to the projection controller device (e.g., step 560). In some examples, executed feedback engine 402 may provide the adjustment data, such as adjustment data 404, to projection controller 312. Projection controller 312 may cause the one or more projection devices 103 to project the corresponding content item in accordance with the adjusted one or more project parameters included in the adjustment data. The one or more projection devices 103 may project the one or more content items in accordance with the adjusted one or more projection parameters instead of the one or more projection parameters executed projection engine 300 initially provided to projection controller 312. As described herein, AV 102, such as perception stack 112 and executed feedback engine 402 may repeat such steps until the attributes of the object or corresponding content item meet the one or more parameter criteria.

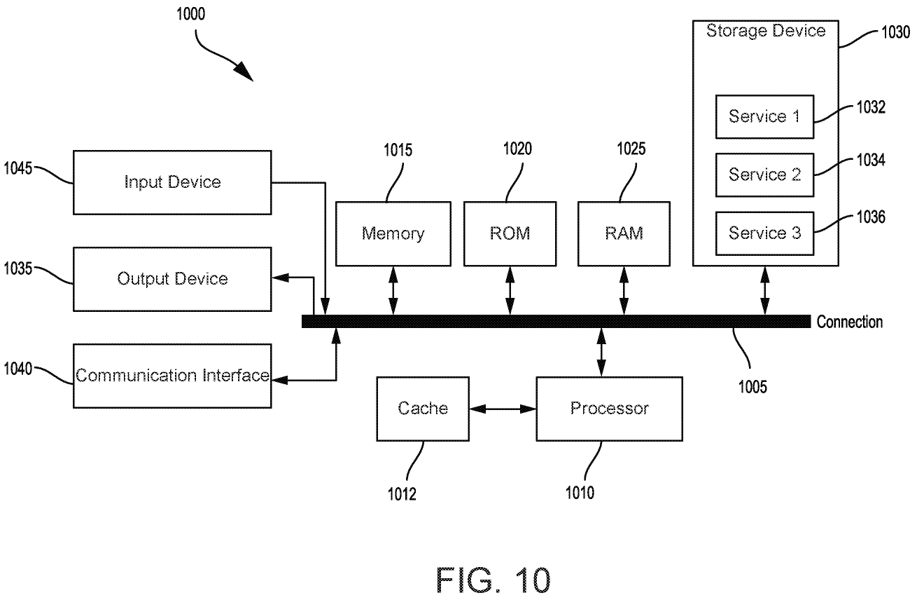

In FIG. 10, the disclosure now turns to a further discussion of models that can be used through the environments and techniques described herein. FIG. 10 is an example of a deep learning neural network 1000 that can be used to implement all or a portion of the systems and techniques described herein (e.g., neural network 1000 can be used to implement a perception module (or perception system) as discussed above, such as perception stack 112). An input layer 1020 can be configured to receive sensor data and/or data relating to an environment surrounding an AV. Neural network 1000 includes multiple hidden layers 1022a, 1022b, through 1022n. The hidden layers 1022a, 1022b, through 1022n include “n” number of hidden layers, where “n” is an integer greater than or equal to one. The number of hidden layers can be made to include as many layers as needed for the given application. Neural network 1000 further includes an output layer 1021 that provides an output resulting from the processing performed by the hidden layers 1022a, 1022b, through 1022n.

Neural network 1000 is a multi-layer neural network of interconnected nodes. Each node can represent a piece of information. Information associated with the nodes is shared among the different layers and each layer retains information as information is processed. In some cases, the neural network 1000 can include a feed-forward network, in which case there are no feedback connections where outputs of the network are fed back into itself. In some cases, the neural network 1000 can include a recurrent neural network, which can have loops that allow information to be carried across nodes while reading in input.

Information can be exchanged between nodes through node-to-node interconnections between the various layers. Nodes of the input layer 1020 can activate a set of nodes in the first hidden layer 1022a. For example, as shown, each of the input nodes of the input layer 1020 is connected to each of the nodes of the first hidden layer 1022a. The nodes of the first hidden layer 1022a can transform the information of each input node by applying activation functions to the input node information. The information derived from the transformation can then be passed to and can activate the nodes of the next hidden layer 1022b, which can perform their own designated functions. Example functions include convolutional, up-sampling, data transformation, and/or any other suitable functions. The output of the hidden layer 1022b can then activate nodes of the next hidden layer, and so on. The output of the last hidden layer 1022n can activate one or more nodes of the output layer 1021, at which an output is provided. In some cases, while nodes in the neural network 1000 are shown as having multiple output lines, a node can have a single output and all lines shown as being output from a node represent the same output value.

In some cases, each node or interconnection between nodes can have a weight that is a set of parameters derived from the training of the neural network 1000. Once the neural network 1000 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1000 to be adaptive to inputs and able to learn as more and more data is processed.

The neural network 1000 is pre-trained to process the features from the data in the input layer 1020 using the different hidden layers 1022a, 1022b, through 1022n in order to provide the output through the output layer 1021.

In some cases, the neural network 1000 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 1000 is trained well enough so that the weights of the layers are accurately tuned.

The loss (or error) will be high for the initial training data since the actual values will be much different than the predicted output. The goal of training is to minimize the amount of loss so that the predicted output is the same as the training output. The neural network 1000 can perform a backward pass by determining which inputs (weights) most contributed to the loss of the network, and can adjust the weights so that the loss decreases and is eventually minimized.

The neural network 1000 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 1000 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 11 illustrates an example processor-based system with which some aspects of the subject technology can be implemented. For example, processor-based system 1100 can be any computing device making up, or any component thereof in which the components of the system are in communication with each other using connection 1105. Connection 1105 can be a physical connection via a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (Central Processing Unit (CPU) or processor) 1110 and connection 1105 that couples various system components including system memory 1115, such as Read-Only Memory (ROM) 1120 and Random-Access Memory (RAM) 1125 to processor 1110. Computing system 1100 can include a cache of high-speed memory 1112 connected directly with, in close proximity to, or integrated as part of processor 1110.

Processor 1110 can include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms known to those of skill in the art. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 1130 can include software services, servers, services, etc., that when the code that defines such software is executed by the processor 1110, it causes the system 1100 to perform a function. In some embodiments, a hardware service that performs a particular function can include the software component stored in a computer-readable medium in connection with the necessary hardware components, such as processor 1110, connection 1105, output device 1135, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Illustrative examples of the disclosure include:

Aspect 1: A computer system comprising: a memory storing instructions; and at least one processor coupled to the memory, the at least one processor being configured to execute the instructions to: receive routing data including routing information and road agent information of each of one or more road agents within a predetermined distance threshold of an autonomous vehicle (AV); generate projection data including a content item associated with the routing information and the road agent information; and provide projection data to a projection controller device communicating with one or more projection devices, the projection controller device causing at least one of the one or more projection devices to project the content item onto a surface outside of the AV.

Aspect 2 The computer system of Aspect 1, wherein the projection data includes one or more projection parameters associated with the content item, and wherein the at least one processor is further configured to: receive image data including one or more images; identify an object within the one or more images; determine the object matches the content item based on one or more features of the one or more images and one or more features of the content item; determine the object does not satisfy one or more projection thresholds; and adjust the one or more projection parameters of the content item based on determining the object does not satisfy one or more environmental thresholds.

Aspect 3: The computing system of Aspect 2, wherein the one or more projection parameters is associated with at least one of a brightness parameter and color parameter.

Aspect 4: The computing system of Aspects 1-3, wherein the projection data includes one or more projection parameters associated with the content item and the one or more projection parameters includes at least a projection location parameter, and wherein the at least one processor is further configured to: determine one or more motion characteristics of the one or more road agents; and determine the projection location parameter based on the one or more motion characteristics of the one or more road agents.

Aspect 5: The computing system of Aspects 1-4, wherein the projection data includes one or more projection parameters associated with the content item, and wherein the at least one processor is further configured to: determine a road agent type of each of the one or more road agents; and determine the one or more projection parameters based on the determined road agent type of each of the one or more road agents.

Aspect 6 The computing system of Aspects 1-5, wherein the at least one processor is further configured to: determine a road agent type of each of the one or more road agents; and wherein the content item is further based on the determined road agent type of each of the one or more road agents.

Aspect 7 The computing system of Aspects 1-6, wherein the projection controller device causes the at least one projection device of the one or more projection device to project the content item onto the surface of an AV by: adjusting one or more mechanical or electrical aspects of the at least one projection device based on the projection data.

Aspect 8: A computer-implemented method comprising: receiving routing data including routing information and road agent information of each of one or more road agents within a predetermined distance threshold of an autonomous vehicle (AV); generating projection data including a content item associated with the routing information and the road agent information; and providing projection data to a projection controller device communicating with one or more projection devices, the projection controller device causing at least one of the one or more projection devices to project the content item onto a surface outside of the AV.

Aspect 9: The computer-implemented method of Aspect 8, wherein the projection data includes one or more projection parameters associated with the content item, and wherein the computer-implemented method further comprises: receiving image data including one or more images; identifying an object within the one or more images; determining the object matches the content item based on one or more features of the one or more images and one or more features of the content item; determining the object does not satisfy one or more projection thresholds; and adjusting the one or more projection parameters of the content item based on determining the object does not satisfy one or more environmental thresholds.

Aspect 10 The computer-implemented method of Aspect 9, wherein the one or more projection parameters is associated with at least one of a brightness parameter and color parameter.

Aspect 11 The computer-implemented method of Aspects 8-10, wherein the projection data includes one or more projection parameters associated with the content item and the one or more projection parameters includes at least a projection location parameter, and wherein the computer-implemented method further comprises: determining one or more motion characteristics of the one or more road agents; and determining the projection location parameter based on the one or more motion characteristics of the one or more road agents.

Aspect 12 The computer-implemented method of Aspects 8-11, wherein the projection data includes one or more projection parameters associated with the content item, and wherein the computer-implemented method further comprises: determining a road agent type of each of the one or more road agents; and determining the one or more projection parameters based on the determined road agent type of each of the one or more road agents.

Aspect 13 The computer-implemented of Aspects 8-12, further comprising: determining a road agent type of each of the one or more road agents; and wherein the content item is further based on the determined road agent type of each of the one or more road agents.

Aspect 14. The computer-implemented of Aspects 8-13, wherein the projection controller device causes the at least one projection device of the one or more projection device to project the content item onto the surface of an AV by: adjusting one or more mechanical or electrical aspects of the at least one projection device based on the projection data.

Aspect 15: A tangible, non-transitory computer readable medium storing instructions that, when executed by at least one processor, cause the at least one processor to perform operations comprising: receiving routing data including routing information and road agent information of each of one or more road agents within a predetermined distance threshold of an autonomous vehicle (AV); generating projection data including a content item associated with the routing information and the road agent information; and providing projection data to a projection controller device communicating with one or more projection devices, the projection controller device causing at least one of the one or more projection devices to project the content item onto a surface outside of the AV.

Aspect 16: The tangible, non-transitory computer readable medium of Aspect 15, wherein the projection data includes one or more projection parameters associated with the content item, and wherein the at least one processor further performs operations comprising: receiving image data including one or more images; identifying an object within the one or more images; determining the object matches the content item based on one or more features of the one or more images and one or more features of the content item; determining the object does not satisfy one or more projection thresholds; and adjusting the one or more projection parameters of the content item based on determining the object does not satisfy one or more environmental thresholds.

Aspect 17: The tangible, non-transitory computer readable medium of Aspect 16, wherein the one or more projection parameters is associated with at least one of a brightness parameter and color parameter.

Aspect 18: The tangible, non-transitory computer readable medium of Aspects 15-17, wherein the projection data includes one or more projection parameters associated with the content item and the one or more projection parameters includes at least a projection location parameter, and wherein the at least one processor further performs operations comprising: determining one or more motion characteristics of the one or more road agents; and determining the projection location parameter based on the one or more motion characteristics of the one or more road agents.

Aspect 19: The tangible, non-transitory computer readable medium of Aspects 15-18, wherein the projection data includes one or more projection parameters associated with the content item, and wherein the at least one processor further performs operations comprising: determining a road agent type of each of the one or more road agents; and determining the one or more projection parameters based on the determined road agent type of each of the one or more road agents.

Aspect 20: The tangible, non-transitory computer readable medium of Aspects 15-19, wherein the at least one processor further performs operations comprising: determining a road agent type of each of the one or more road agents; and wherein the content item is further based on the determined road agent type of each of the one or more road agents.

Aspect 21: The computer-implemented of Aspects 15-20, wherein the projection controller device causes the at least one projection device of the one or more projection device to project the content item onto the surface of an AV by: adjusting one or more mechanical or electrical aspects of the at least one projection device based on the projection data.

Aspect 22: A system comprising: one or more sensor systems that generate sensor data, the sensor data including camera data, lidar data, and radar data; a computing system that determines (i) routing information based on the sensor data, (ii) road agent information of one or more road agents within a predetermined distance threshold of an autonomous vehicle (AV), and (iii) a content item based on the routing information and the road agent information; a projection system that projects the content item onto a surface outside of the AV; a feedback system that adjusts one or more projection parameters of the projected content item based on sensor data associated with the projected content item.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computing system comprising:
a memory storing instructions; and
at least one processor coupled to the memory, the at least one processor being configured to execute the instructions to:
receive routing data including routing information and road agent information of each of one or more road agents within a predetermined distance threshold of an autonomous vehicle (AV);
generate projection data including a content item associated with the routing information and the road agent information; and
provide projection data to a projection controller device communicating with one or more projection devices, the projection controller device causing at least one of the one or more projection devices to project the content item onto a surface outside of the AV.

2. The computing system of claim 1, wherein the projection data includes one or more projection parameters associated with the content item, and wherein the at least one processor is further configured to:
receive image data including one or more images;
identify an object within the one or more images;
determine the object matches the content item based on one or more features of the one or more images and one or more features of the content item;
determine the object does not satisfy one or more projection thresholds; and
adjust the one or more projection parameters of the content item based on determining the object does not satisfy one or more environmental thresholds.

3. The computing system of claim 2, wherein the one or more projection parameters is associated with at least one of a brightness parameter and color parameter.

4. The computing system of claim 1, wherein the projection data includes one or more projection parameters associated with the content item and the one or more projection parameters includes at least a projection location parameter, and wherein the at least one processor is further configured to:
determine one or more motion characteristics of the one or more road agents; and
determine the projection location parameter based on the one or more motion characteristics of the one or more road agents.

5. The computing system of claim 1, wherein the projection data includes one or more projection parameters associated with the content item, and wherein the at least one processor is further configured to:
determine a road agent type of each of the one or more road agents; and
determine the one or more projection parameters based on the determined road agent type of each of the one or more road agents.

6. The computing system of claim 1, wherein the at least one processor is further configured to:
determine a road agent type of each of the one or more road agents; and
wherein the content item is further based on the determined road agent type of each of the one or more road agents.

7. The computing system of claim 1, wherein the projection controller device causes the at least one projection device of the one or more projection device to project the content item onto the surface of an AV by:
adjusting one or more mechanical or electrical aspects of the at least one projection device based on the projection data.

8. A computer-implemented method comprising:
receiving routing data including routing information and road agent information of each of one or more road agents within a predetermined distance threshold of an autonomous vehicle (AV);
generating projection data including a content item associated with the routing information and the road agent information; and
providing projection data to a projection controller device communicating with one or more projection devices, the projection controller device causing at least one of the one or more projection devices to project the content item onto a surface outside of the AV.

9. The computer-implemented method of claim 8, wherein the projection data includes one or more projection parameters associated with the content item, and wherein the computer-implemented method further comprises:
receiving image data including one or more images;
identifying an object within the one or more images;
determining the object matches the content item based on one or more features of the one or more images and one or more features of the content item;
determining the object does not satisfy one or more projection thresholds; and
adjusting the one or more projection parameters of the content item based on determining the object does not satisfy one or more environmental thresholds.

10. The computer-implemented method of claim 9, wherein the one or more projection parameters is associated with at least one of a brightness parameter and color parameter.

11. The computer-implemented method of claim 8, wherein the projection data includes one or more projection parameters associated with the content item and the one or more projection parameters includes at least a projection location parameter, and wherein the computer-implemented method further comprises:
determining one or more motion characteristics of the one or more road agents; and
determining the projection location parameter based on the one or more motion characteristics of the one or more road agents.

12. The computer-implemented method of claim 8, wherein the projection data includes one or more projection parameters associated with the content item, and wherein the computer-implemented method further comprises:
determining a road agent type of each of the one or more road agents; and
determining the one or more projection parameters based on the determined road agent type of each of the one or more road agents.

13. The computer-implemented of claim 8, further comprising:
determining a road agent type of each of the one or more road agents; and
wherein the content item is further based on the determined road agent type of each of the one or more road agents.

14. The computer-implemented of claim 8, wherein the projection controller device causes the at least one projection device of the one or more projection device to project the content item onto the surface of an AV by:
adjusting one or more mechanical or electrical aspects of the at least one projection device based on the projection data.

15. A tangible, non-transitory computer readable medium storing instructions that, when executed by at least one processor, cause the at least one processor to perform operations comprising:
receiving routing data including routing information and road agent information of each of one or more road agents within a predetermined distance threshold of an autonomous vehicle (AV);
generating projection data including a content item associated with the routing information and the road agent information; and
providing projection data to a projection controller device communicating with one or more projection devices, the projection controller device causing at least one of the one or more projection devices to project the content item onto a surface outside of the AV.

16. The tangible, non-transitory computer readable medium of claim 15, wherein the projection data includes one or more projection parameters associated with the content item, and wherein the at least one processor further performs operations comprising:
receiving image data including one or more images;
identifying an object within the one or more images;
determining the object matches the content item based on one or more features of the one or more images and one or more features of the content item;
determining the object does not satisfy one or more projection thresholds; and
adjusting the one or more projection parameters of the content item based on determining the object does not satisfy one or more environmental thresholds.

17. The tangible, non-transitory computer readable medium of claim 16, wherein the one or more projection parameters is associated with at least one of a brightness parameter and color parameter.

18. The tangible, non-transitory computer readable medium of claim 15, wherein the projection data includes one or more projection parameters associated with the content item and the one or more projection parameters includes at least a projection location parameter, and wherein the at least one processor further performs operations comprising:
determining one or more motion characteristics of the one or more road agents; and
determining the projection location parameter based on the one or more motion characteristics of the one or more road agents.

19. The tangible, non-transitory computer readable medium of claim 15, wherein the projection data includes one or more projection parameters associated with the content item, and wherein the at least one processor further performs operations comprising:
determining a road agent type of each of the one or more road agents; and
determining the one or more projection parameters based on the determined road agent type of each of the one or more road agents.

20. The tangible, non-transitory computer readable medium of claim 15, wherein the at least one processor further performs operations comprising:
determining a road agent type of each of the one or more road agents; and
wherein the content item is further based on the determined road agent type of each of the one or more road agents.
